(19) United States
(12) Patent Application Publication
(10) Pub. No.: US 2019/0031549 A1
(43) Pub. Date: Jan. 31, 2019

(54) PROCESSES FOR THERMAL STRENGTHENING OF GLASS USING LIQUID CONDUCTION

(71) Applicant: CORNING INCORPORATED, Corning, NY (US)

(72) Inventors: John Christopher THOMAS, Elmira, NY (US); Kevin Lee WASSON, Elmira, NY (US)

(73) Assignee: CORNINING NINCORPORATED, Corning, NY (US)

(21) Appl. No.: 16/073,601

(22) PCT Filed: Jan. 27, 2017
(86) PCT No.: PCT/US2017/015260

§ 371 Date: Jul. 27, 2018

Related U.S. Application Data
(60) Provisional application No. 62/288,177, filed on Jan. 28, 2016.
(60) Provisional application No. 62/288,615, filed on Jan. 29, 2016.
(60) Provisional application No. 62/428,142, filed on Nov. 30, 2016.
(60) Provisional application No. 62/428,168, filed on Nov. 30, 2016.

(51) Int. Cl. C03B 27/02; C03B 35/22; C03B 27/03

(52) U.S. Cl. CPC C03B 27/02; C03B 27/03; C03B 35/22

(57) ABSTRACT

A process of strengthening a glass sheet by cooling a sheet or portion of a sheet, the sheet comprising or consisting of a glass having a glass transition temperature, given in units of ° C., of T, wherein the cooling is performed starting with the sheet at a temperature above T, with more than 20%, 30%, 40% or 50% or more of said cooling, at some point during said cooling, being by thermal conduction through a liquid to a heat sink surface comprising a solid.

This application claims the benefit of priority under 35 U.S.C. § 119 of U.S. Provisional Application Ser. No. 62/288,177 filed on Jan. 28, 2016; U.S. Provisional Application Ser. No. 62/288,615 filed on Jan. 29, 2016; U.S. Provisional Application Ser. No. 62/428,142 filed on Nov. 30, 2016; and U.S. Provisional Application Ser. No. 62/428,168, filed on Nov. 30, 2016, the contents of which are relied upon and incorporated herein by reference in their entirety.

This application is related to and hereby incorporates herein by reference in full the following applications: Provisional Application Ser. No. 62/288,851, filed on Jan. 29, 2016, U.S. application Ser. No. 14/814,232, filed on Jul. 30, 2015; U.S. application Ser. No. 14/814,181, filed on Jul. 30, 2015; U.S. application Ser. No. 14/814,274, filed on Jul. 30, 2015; U.S. application Ser. No. 14/814,293, filed on Jul. 30, 2015; U.S. application Ser. No. 14/814,303, filed on Jul. 30, 2015; U.S. application Ser. No. 14/814,363, filed on Jul. 30, 2015; U.S. application Ser. No. 14/814,319, filed on Jul. 30, 2015; U.S. application Ser. No. 14/814,335, filed on Jul. 30, 2015; U.S. Provisional Application No. 62/031,856, filed Jul. 31, 2014; U.S. Provisional Application No. 62/074,838, filed Nov. 4, 2014; U.S. Provisional Application No. 62/031,856, filed Apr. 14, 2015; U.S. application Ser. No. 14/814,232, filed Jul. 30, 2015; U.S. application Ser. No. 14/814,181, filed Jul. 30, 2015; U.S. application Ser. No. 14/814,274, filed Jul. 30, 2015; U.S. application Ser. No. 14/814,293, filed Jul. 30, 2015; U.S. application Ser. No. 14/814,303, filed Jul. 30, 2015; U.S. application Ser. No. 14/814,363, filed Jul. 30, 2015; U.S. application Ser. No. 14/814,319, filed Jul. 30, 2015; U.S. application Ser. No. 14/814,335, filed Jul. 30, 2015; U.S. Provisional Application No. 62/236,296, filed Oct. 2, 2015; U.S. Provisional Application No. 62/288,549, filed Jan. 29, 2016; U.S. Provisional Application No. 62/288,566, filed Jan. 29, 2016; U.S. Provisional Application No. 62/288,615, filed Jan. 29, 2016; U.S. Provisional Application No. 62/288,695, filed on Jan. 29, 2016; U.S. Provisional Application No. 62/288,755, filed on Jan. 29, 2016.

### FIELD

The application relates generally to thermally treated glass, defined as including glass and glass ceramics and materials comprising glass, and specifically relates to processes for the thermal strengthening of glass using liquid-mediated thermal conduction.

### BACKGROUND

In thermal (or “physical”) strengthening of sheets comprising glass (“glass sheets”), a glass sheet is heated to an elevated temperature above the glass transition temperature of the glass and then the surfaces of the sheet are rapidly cooled (“quenched”) while the inner regions of the sheet cool at a slower rate. The inner regions cool more slowly because they are insulated by the thickness and the fairly low thermal conductivity of the glass. The differential cooling produces a residual compressive stress in the sheet surface regions, balanced by a residual tensile stress in the central regions of the sheet.

Thermal strengthening of glass is distinguished from chemical strengthening of glass, in which surface compressive stresses are generated by changing the chemical composition of the glass in regions near the surface by a process such as ion diffusion. In some ion diffusion based processes, exterior portions of glass may be strengthened by exchanging larger ions for smaller ions near the glass surface to impart a compressive stress (also called negative tensile stress) on or near the surface.

Thermal strengthening of glass is also distinguished from glass strengthened by processes in which exterior portions of the glass are strengthened or arranged by combining two types of glass. In such processes, layers of glass compositions that have differing coefficients of thermal expansion are combined or laminated together while hot. For example, by sandwiching molten glass with a higher coefficient of thermal expansion (CTE) between layers of molten glass with a lower CTE, positive tension in the interior glass compresses the outer layers when the glasses cool, again forming compressive stress on the surface to balance the positive tensile stress.

Thermally strengthened glass has advantages relative to unstrengthened glass. The surface compression of the strengthened glass provides greater resistance to fracture than unstrengthened glass. The increase in strength generally is proportional to the amount of surface compression stress. If a sheet possesses a sufficient level of thermal strengthening, relative to its thickness, then if the sheet is broken, generally it will divide into small fragments rather than into large or elongated fragments with sharp edges. Glass that breaks into sufficiently small fragments, or “dices,” as defined by various established standards, may be known as safety glass, or “fully tempered” glass, or sometimes simply “tempered” glass.

Because the degree of strengthening depends on the temperature difference between the surface and center of the glass sheet during quenching, thinner glasses require higher cooling rates to achieve a given stress. Also, thinner glass generally requires higher values of surface compressive stress and central tension stress to achieve dicing into small particles upon breaking.

### SUMMARY

Aspects of the present disclosure also relate generally to a glass that has a stress profile for strengthening exterior portions thereof. Glass, such as sheets of glass, may be used for a broad range of applications. Examples of such applications include use in windows, countertops, containers (e.g., food, chemical), use as a backplane, frontplane, cover glass, etc., for a display device (e.g., tablet, cellular phone, television), use as a high-temperature substrate or support structure, or other applications.

According to embodiments of the present disclosure, a glass sheet is thermally strengthened by cooling a sheet or portion of a sheet, the sheet comprising or consisting of a glass having a glass transition temperature, given in units of ° C., of T, wherein the cooling is performed starting with the sheet at a temperature above T, with more than 20%, 30%, 40% or 50% or more of said cooling, at some point during said cooling, being by thermal conduction through a liquid to a heat sink surface comprising a solid.

According to embodiments, a glass sheet is thermally strengthened by a process comprising (a) supporting at least a portion of a glass sheet on a first surface thereof, at least in part, by a flow or a pressure of a liquid delivered to a first gap between the first surface and a first heat sink surface, the first heat sink surface comprising a solid, wherein the sheet comprises or consists of a glass having a glass transition temperature and the sheet is at a temperature greater than the glass transition temperature of the glass, and (b) cooling the sheet, with more than 20%, 30%, 40% or even 50% or more of said cooling being by thermal conduction from the first surface of the sheet across the first gap through the liquid to the first heat sink surface.

### BRIEF DESCRIPTION OF THE FIGURES

FIG. 1 is a cross sectional diagram of a thermal tempering apparatus according to the present disclosure performing a thermal tempering process according to the present disclosure.

FIG. 2 is a cross sectional diagram of another embodiment or aspect of a thermal tempering apparatus according to the present disclosure capable of performing another aspect of a thermal tempering process according to the present disclosure.

FIG. 3 is a cross sectional diagram of yet another embodiment or aspect of a thermal tempering apparatus according to the present disclosure capable of performing yet another aspect of a thermal tempering process according to the present disclosure.

FIG. 4 is an illustrative graph of pressure provided by a dual sided fluid bearing such as may be used according to the present disclosure.

### DETAILED DESCRIPTION

In embodiments, a process is provided by which a glass article (herein, the term “glass” includes glass ceramic) is positioned between opposing liquid bearings and is conveyed from one zone to an adjacent zone which is at a different temperature in order to heat or cool a surface of the article predominantly by heat conduction across the fluid gap. The liquid bearings may be of a discrete hole type with or without added compensation restrictors, or they may be a bulk porous media type. Exemplary liquids are molten salts and molten metals. The gaps of the liquid bearings may be changeable, either during set-up, or during the actual heat transfer process (e.g., the glass may be conveyed into a zone and then the gaps may be opened or closed at a prescribed rate to achieve a desirable heat transfer profile as a function of time).

Additionally, embodiments include an article supported by liquid bearings that is traversed at a prescribed speed through a heat exchange region which includes heat transfer lands in order to cause a heating or a cooling to the surface of the article that is predominantly by heat conduction across the liquid gap.

Embodiments enable the article to be thermally processed with rates of heat transfer (heating or cooling) that are higher, more uniform, more deterministic, and more controllable than can be achieved by immersion into a liquid bath (whether stirred or otherwise agitated or flowed or not) or by being sprayed or otherwise contacted with a moving liquid. In the case of glass articles that are prone to distortion and warping during different stages of their thermal treatment, embodiments allow the thermal processing to occur without contacting the article with a solid form (roller, grid, etc.) and yet while constraining the article in a desired shape by the stiffness of the centering action of the liquid bearings.

Embodiments include strengthening (thermal tempering) of thin glass sheets (sheets) using processes and equipment which can be quantitatively modeled and are generally simpler than ion exchange. Compared to other thermal tempering methods, embodiments enable a higher rate of cooling heat transfer from the sheets or articles, thereby enabling a higher degree of thermal tempering. It also offers a higher degree of uniformity of tempering than can be achieved with convective jetted air cooling used for conventional glass tempering.

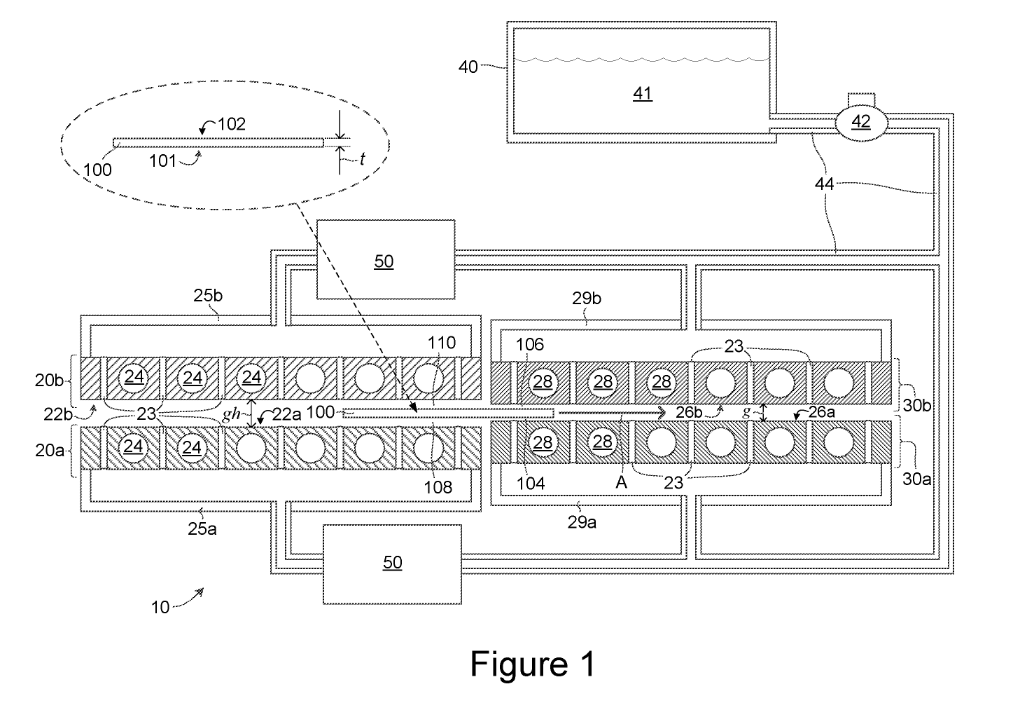

FIG. 1 shows a schematic diagram of a sheet or article 100 that is positioned between the opposing first and second surfaces 22a, 22b of opposing heating liquid bearings 20a and 20b, as well as between opposing first and second surfaces 26a, 26b of cooling liquid bearings 30a and 30b. Each of the bearings 20a, 20b, 30a, 30b is supplied with liquid by suitable means—in this embodiment, by a pump 42 bringing liquid 41 from a reservoir 40, through conduits 44 to respective plenums 25a, 25b, 29a, 29b. The sheet 100 is desirably centered between the respective bearing surfaces by the opposing liquid pressures from the opposing bearings. The liquid bearings may be of the discrete-hole type with or without added compensation restrictors, or they may be a bulk porous media type.

For thermal strengthening, the sheet 100 may first be heated between the heating liquid bearings 20a, 20b to a temperature above the glass transition of a glass of which the sheet is comprised, then conveyed as represented in the figure in the direction of arrow A, in order to be cooled between the cooling liquid bearings 30a, 30b to a temperature below the glass transition.

As an alternative embodiment to the embodiment shown, the liquid may not be the same for each the four bearing members.

In embodiments in which molten salts or metals are used as the bearing liquid(s), heating elements, such as cartridge heaters 24, 28, embedded in the liquid bearings 20a, 20b, 30a, 30b, are used to control the two pairs of liquid bearings 20a & 20b, 30a & 30b to different set-point temperatures which are above the (respective) bearing liquid melting point. Optionally, additional heaters 50 may be employed at a position along the conduits 43 leading to the heating liquid bearings 20a, 20b. If heating is not required to prevent solidification of the bearing liquid(s), generally either bearing may be heated or cooled as needed to achieve the temperature most beneficial for the desired thermal processing. In this case, as an alternative embodiment, reference character 28 of FIG. 1 may indicate a coolant passage, for example, rather than a cartridge heater, for providing cooling to the cooling the cooling liquid bearings 30a, 30b.

The size of the gaps g, gh of the two pairs of liquid bearings can be equal or different (as shown) and may be independently changeable either during set-up or during the actual heat transfer process (e.g., the glass may be conveyed into a zone and then the gaps may be opened or closed at a prescribed rate to achieve a desirable heat transfer profile in time). The sheet 100 can be conveyed from one pair of bearings to the next in order to cause a change in its temperature at a desired rate of heat transfer.

In accordance with FIG. 1, the sheet 100 (as shown in inset) has a thickness t and first and second (major) surfaces 101 and 102. Features of the apparatus (10), useful for thermally strengthening a glass sheet (100), comprise: a first heat sink surface (26a), a second heat sink surface (26b) separated from said first heat sink surface (26a) by a gap g between the heat sink surfaces, and a liquid feed structure (40, 42, 44, 27a, 27b) positioned to be able to feed a liquid to the gap g. The gap g is sized sufficiently small relative to a thickness t of a glass sheet (100) such that when the sheet (100) of thickness t is positioned within the gap g, thermal transfer from a first surface (101) of the sheet (100) facing the first heat sink surface (26a) is more than 20% by conduction from the first surface (101) of the sheet (100) through the liquid to the first heat sink surface (26a). The percentage of thermal transfer from the first surface which is effected by thermal conduction may desirably be even higher, such as greater than 30%, greater than 40%, greater than 50%, greater than 60%, greater than 70%, greater than 80% and even greater than 90% by thermal conduction. A difference in size between the gap G and the thickness t of the sheet 100, g−t, may be desirably less than 500 μm or even smaller, such as less than 400 μm, less than 300 μm, 200 μm, 100 μm, 90 μm, 80 μm, 70 μm, 60 μm, 50 μm, and even less than 40 μm.

In embodiments, the liquid feed structure further comprises one or more liquid feed openings 23 in the first heat sink surface 26a, as seen in FIG. 1. In alternative embodiments, such as those described below in reference to FIG. 3, a first heat sink (and/or first heat source) surface comprises no liquid feed openings. According to further alternative embodiments, the first and second heat sink surfaces 26a, 26b may be flat, or curved each with a single axis of curvature, or curved each with two axes of curvature.

Further in accord with the embodiment(s) as shown in FIG. 1, the apparatus 10 may further comprise a first heat source surface (22a), a second heat source surface (22b) separated from said first heat source surface (22a) by a heat source gap gh, and a liquid feed structure (40, 42, 44, 25a, 25b) (in the embodiment of FIG. 1, the liquid feed structure for the first and second heat source surfaces is essentially the same structure as for the heat sink surfaces but this need not be so) positioned to be able to feed a liquid to the heat source gap. The heat source gap gh is sufficiently small relative to a thickness t of a glass sheet (100) such that when a sheet (100) of thickness t is positioned within the heat source gap gh, thermal transfer from the first heat source surface (22a) to a facing first surface (101) of the sheet (100) is more than 20% by conduction from the first heat source surface (22a) through the liquid to the first surface (101) of the sheet (100), desirably more than 30%, 40%, 50%, 60%, 70%, 80%, and even more than 90%.

The article in the form of sheet 100 may be conveyed from one zone to the next at a speed that may be desirable to create favorable thermal conditions for processing the material. For example, a speed may be used that is so great that the change in temperature state of the material during the transition is negligible compared to its change in temperature state once it is fully immersed in the next zone; alternatively a speed may be used that is slow, such that there is a distinct difference in the temperature state of the sheet corresponding to where it is located in the system; and any desirable speed in between these two extreme conditions may be employed.

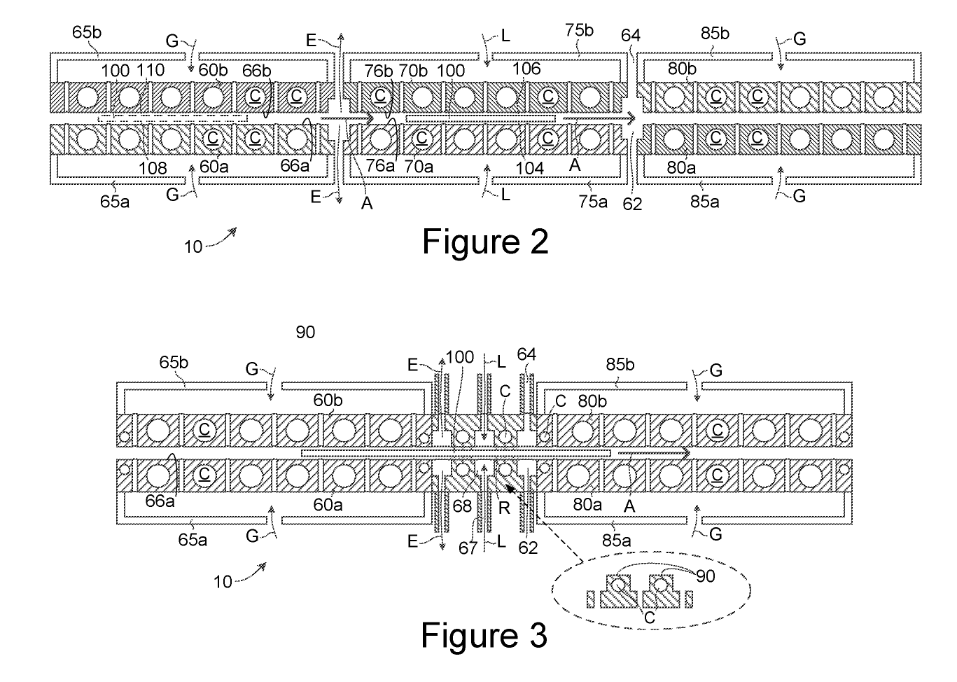

FIG. 2 shows a schematic diagram of yet another embodiment of the present disclosure, comprising an apparatus 10 in which an article or sheet 100 to be processed is conveyed from gas bearings 60a, 60b to central liquid bearings 70a, 70b and then to a second pair of gas bearings 80a, 80b. Gas plenums 65a, 65b assist to distribute gas G to the gas bearings 60a, 60b. Similarly, gas plenums 85a, 85b assist to distribute gas G to the gas bearings 80a, 80b. Liquid plenums 75a, 75b assist in distributing liquid L to the liquid bearings 70a, 70b. Channels C (four of which are labeled in each bearing) may be included in each bearing 60a, 60b, 70a, 70b, 80a, 80b and may be used temperature control, as passages for heat exchange fluid, or as locations for cartridge heaters, or the like.

Similarly to described embodiments, either of the liquid and gas bearings may be of the discrete hole type with or without added compensation restrictors, or they may be a bulk porous media type bearing. The temperatures and gaps of each set of bearings may be different.

Pressurized gas emanating from the gas bearings 60a, 60b, 80a, 80b prevents the liquid L from entering the gaps between gas bearings and also acts to strip the liquid from the sheet as it leaves the liquid bearing region. Likewise, the liquid emanating from the liquid bearings 70a, 70b prevents gas from entering the liquid bearing gaps.

The liquid/gas mixture that is created at the transition between the different types of bearings may be gathered in a chamber 62 positioned between the different types of bearings and expelled or withdrawn from the chamber 62 as exhaust E via a passage 64. The exhausted gas-liquid mixture can be returned to a reservoir (not shown) where the gas may be allowed to separate, and the liquid may then be temperature controlled and recirculated.

The sheet can be conveyed from one pair of bearings to the next, such as in the direction indicated by arrow A, in order to cause a change in its temperature at a prescribed rate of heat transfer. In this embodiment as in previously described embodiments, the material or sheet 100 under treatment can be conveyed from one zone to the next at a speed that may be desirable to create favorable thermal conditions for processing the material. For example, a speed that is so great that the change in temperature state of the material during the transition is negligible compared to its change in temperature state once it is fully immersed in the next zone; a speed that is slow such that there is a distinct difference in the temperature state of the material corresponding to where it is located in the system; and any desirable speed in between these two extreme conditions.

FIG. 3 shows a schematic diagram of still another alternative embodiment. In the apparatus 10 of FIG. 3, a sheet 100, as it is processed (for example, in the direction indicated by the arrow A) is first centered between opposing gas bearings 60a, 60b and then conveyed through a region R, where a liquid L, supplied through conduits 67 to chambers 62, circulates across heat transfer lands 90. The sheet 100 is then received by opposing gas bearings 80a, 80b as the sheet progresses in the direction of arrow A. Channels C (of two sizes in the embodiment shown) may be included in the gas bearings 60a, 60b, 80a, 80b for thermal control. Similarly, channels C may also be included, and are desirably included, in close proximity to the heat transfer lands 90 for removing heat from (or, in some applications, providing heat to) the lands 90.

Similarly to the various other embodiments, the gas bearings may be of the discrete hole type with or without added compensation restrictors, or they may be of the bulk porous media type. Gas emanating from the gas bearings 60a, 60b, 80a, 80b prevents the liquid L from entering the baps between the gas bearings. Likewise, liquid leaving the regions R prevents gas from entering the gaps between the heat transfer lands 90. The resulting liquid/gas mixture can be collected in chambers 62 and expelled or withdrawn through passages 64 in the form of exhaust E. As in the embodiment(s) of FIG. 2, the gas-liquid mixture of exhaust E may be returned to a reservoir (not shown) where the gas may be allowed to separate, and the liquid can be temperature controlled and recirculated.

In this embodiment, since the region where liquid heat transfer occurs is not a bearing in the sense of having capability to strongly center the sheet 100 if the sheet 100 moves off center, the sheet 100 preferably is sufficiently long in the direction of arrow A to span between the first pair of air bearings 60a, 60b and the second pair of air bearings 80a, 80b for centralization.

In embodiments described above, the sheet may be discrete pieces of fixed length, or they may be instead in the form of a continuous sheet longer than the bearing system provided.

The various equipment embodiments and alternatives described above enable a process of strengthening a glass sheet, described here with reference to FIGS. 1 and 2. The process comprises supporting at least a portion of a glass sheet 100 on a first surface 101 thereof, at least in part, by a flow or a pressure of a liquid (41 or L) delivered to a first gap 104 between the first surface 101 and a first heat sink surface 26a, 76a, the first heat sink surface 26a, 76a comprising a solid, wherein the sheet 100 comprises or consists of a glass having a glass transition temperature and the sheet 100 is at a temperature greater than the glass transition temperature of the glass, and cooling the first surface 101 of the sheet 100, with more than 20% of said cooling being by thermal conduction from the first surface 101 of the sheet 100 across the first gap 104 through the liquid to the first heat sink surface 26a, 76a.

The process may additionally comprise contacting at least a portion of the glass sheet 100 on a second surface 102 thereof, at least in part, with a flow or a pressure of a liquid 41, L delivered to a second gap 106 between the second surface 102 and a second heat sink surface 26b, 76b, the second heat sink surface 26b, 76b comprising a solid, and cooling the second surface 102 of the sheet 100, with more than 20% of said cooling being by thermal conduction from the second surface 102 of the sheet 100 across the second gap 106 through the liquid to the second heat sink surface 26b, 76b.

The above processes may additionally comprise, prior to cooling the sheet 100, heating the first surface 101 of the sheet 100, with more than 20% of said heating being by thermal conduction from a first heat source surface 22a, 60a across a third gap 108 through a fluid 41, L to the first surface 101 of the sheet 100, as well as, prior to cooling the sheet 100, heating the second surface 102 of the sheet 100, with more than 20% of said heating being by thermal conduction from a second heat source surface 22b, 60b across a fourth gap 110 through a heat conduction fluid 41, G, to the second surface 102 of the sheet 100. The fluid may be a liquid 41 as in the embodiment of FIG. 1 or a gas G as in the embodiment of FIG. 2.

According to process embodiments with reference to FIGS. 1, 2, and 3, the disclosed process may also comprise cooling a sheet 100, the sheet comprising or consisting of a glass having a glass transition temperature, given in units of ° C., of T, wherein the cooling is performed (a) starting with the sheet at a temperature above T, (b) with more than 20% of said cooling, at some point during said cooling, being by thermal conduction through a liquid 41, L to a heat sink surface 26a, 66a, 90, comprising a solid. The process with reference to FIGS. 1, 2, and 3 may further comprise, prior to cooling the sheet 100, heating the sheet 100, wherein the heating is performed with more than 20% of said heating, at some point during said heating, being by thermal conduction from a heat source surface 22a, 66a through a fluid 41, G to the sheet 100.

According to embodiments also with reference to FIGS. 1, 2, and 3, there is provided a process for heat treating an article, the process comprising heating or cooling an article, with at least 50% of said heating or cooling performed, during at least some time of said heating or cooling, by thermal conduction through a liquid to a heat sink surface comprising a solid.

In any of the above-described processes, cooling is desirably performed to below a temperature of T±0.20·T° C., or T±0.10·T° C., T±0.05·T° C., or T° C. Further, in any of the above-described processes, the percentage of cooling which is by thermal conduction is desirably even higher than greater than 20%, such as greater than 30%, 40%, 50%, 60%, 70%, 80% or even greater than 90%, or even as great as 99% or more by thermal conduction. Likewise, in any of the above-described processes, the percentage of heating which is by thermal conduction is desirably even higher than greater than 20%, such as greater than 30%, 40%, 50%, 60%, 70%, 80% or even greater than 90%, or even as great as 99% or more by thermal conduction.

Process and equipment embodiments of the present disclosure use conduction across a narrow gap filled with a fluid to transfer heat to or from a material, desirably to or from a glass material in the form of a glass sheet. For a fluid gap such as occurs in a fluid bearing, the conduction component of the heat transfer rate is determined by the thermal conductivity of the fluid in the gap, the size of the gap, and the temperatures of the material in the gap and of the bearings:

$${Q}_{conduction} = {A}_{g} ( {T}_{g} - {T}_{b} ) \frac{k}{g} \qquad ( 1 )$$

Where Qconduction is the heat transfer rate, Ag is the projected area of the part (length times width), Tg is the temperature of the surface of the material, Tb is the temperature of the surface of the bearing, and k is the thermal conductivity of the fluid in the gap. Since most fluids have a temperature-dependent thermal conductivity, a more general relation is:

$${Q}_{conduction} = \frac{{A}_{g}}{g} {\int }_{{T}_{g}}^{{T}_{b}} k ( T ) dT \qquad ( 2 )$$

Shown for reference below are the thermal conductivities as a function of temperature for some common gases.

TABLE 1

| Temp. | | | | | | | | | | | |
|---|---|---|---|---|---|---|---|---|---|---|---|
| ° C. | Air | N2 | Ar | CO2 | He | H2 | O2 | Steam@1 atm | Ne | Methane | Propane |
| 27 | 0.0267 | 0.0267 | 0.0176 | 0.0131 | 0.149 | 0.198 | 0.0274 | | 0.0539 | 0.0341 | 0.0202 |
| 127 | 0.0331 | 0.0326 | 0.0223 | 0.0259 | 0.178 | 0.227 | 0.0348 | 0.0277 | 0.0618 | 0.0491 | 0.0306 |
| 227 | 0.0389 | 0.0383 | 0.0265 | 0.0333 | 0.205 | 0.259 | 0.042 | 0.0365 | 0.0697 | 0.0665 | 0.0455 |
| 327 | 0.0447 | 0.044 | 0.0302 | 0.0407 | 0.229 | 0.299 | 0.049 | 0.046 | 0.0775 | 0.0841 | 0.0619 |
| 527 | 0.0559 | 0.055 | 0.0369 | 0.0544 | 0.273 | 0.365 | 0.062 | 0.066 | 0.0933 | 0.1193 | 0.0947 |
| 727 | 0.0672 | 0.066 | 0.0427 | 0.0665 | 0.318 | 0.423 | 0.074 | 0.088 | 0.1090 | 0.1545 | 0.1275 |

Since the thermal conductivity of most gases is very linear with temperature, a very good approximation is to use Equation 1 and the conductivity of the gas evaluated at the average temperature (Tb+Tg)/2. For processing of some common glass compositions with bearings at approximately room temperature, this average temperature is approximately 377° C. Shown below is the average thermal conductivity of various gases evaluated at this temperature, as well as a comparison to the rate of conduction that can be achieved using air.

TABLE 2

| | Air | N2 | Ar | CO2 | He | H2 | O2 | Steam@1 atm | Ne | Methane | Propane |
|---|---|---|---|---|---|---|---|---|---|---|---|
| Evaluated at average gap | 0.0470 | 0.0464 | 0.0302 | 0.0423 | 0.2335 | 0.3105 | 0.0507 | 0.0440 | 0.0815 | 0.0943 | 0.0739 |
| temperature of 377° C.: | | | | | | | | | | | |
| Ratio to Air: | 1.00 | 0.98 | 0.66 | 0.92 | 5.02 | 6.60 | 1.09 | 1.07 | 1.72 | 1.97 | 1.50 |

As shown, there is a strong incentive to use helium or hydrogen. Since (unlike hydrogen) helium is inert and non-combustible, it is a very desirable gas for this process. However, it is expensive and supply may be uncertain. There is therefore an incentive to design equipment to minimize or avoid the use of the high conductivity gas.

The present disclosure provides for the use of liquids as the heat transfer fluid which fills the gap. Some requirements and desirables for this liquid are that it be economical, health-friendly, eco-friendly, and stable at the desirable operating temperatures. It is also desirable that the liquid has a high thermal conductivity, such that relatively large gaps can be used, or relatively high heat transfer rates can be produced, or both. An additional desirable quality is that, when operating at gaps that will deliver the desired heat transfer rate, the liquid can be used as a hydrostatic bearing fluid with reasonable flow rates that are amenable to conventional pumping systems with low pumping power requirements, and that the heat transfer due to convection between the sheet and the liquid is small relative to the conduction term across the gap.

A particular focus of this effort is to thermally temper glass, a process in which the glass temperatures typically range from 630° C. to 900° C. Liquids that can be readily used at these temperatures without phase change or degradation include molten salts and molten metals. For example, molten salts and metals listed with relevant material properties are shown in Table 3.

TABLE 3

| | | | | Specific | |
|---|---|---|---|---|---|
| | Melting | Thermal | | Heat | Dynamic |
| | Temperature | Conductivity | Density | Capacity | Viscosity |
| | (° C.) | (W/m · K) | (kg/m³) | (J/kg · °K) | (Pa · s) |
| Potassium Nitrate, | 334 | 0.41 @ 350° C. | 1865 | 1370 | 0.00278 @ 350° C. |
| KNO₃ | | 0.32 @ 525° C. | | | 0.00134 @ 525° C. |
| Sodium Nitrate, | 308 | 0.51 @ 320° C. | 1900 | 1650 | 0.00285 @ 320° C. |
| NaNO₃ | | 0.47 @ 510° C. | | | 0.0010 @ 510° C. |
| Tin, Sn | 232 | 30 @ 240° C. | 6950 | 210 | 0.0019 @ 250° C. |
| | | 36 @ 470° C. | | | 0.0012 @ 470° C. |
| Lead, Pb | 327 | 16 @ 330° C. | 10600 | 160 | 0.00265 @ 330° C. |
| | | 19 @ 515° C. | | | 0.00177 @ 515° C. |
| Sodium, Na | 98 | 84 @ 110° C. | 930 | 1364 | 0.00055 @ 110° C. |
| | | 71 @ 405° C. | | | 0.00026 @ 405° C. |

Regarding the relative contributions of conduction and convection, whether for heating or cooling, the convective Qconv component of the rate heat transfer across the gap (or gaps) may be given by:

$${Q}_{conv} = e \dot{m} {C}_{p} ( \frac{{T}_{S} + {T}_{HS}}{2} - {T}_{i} ) \qquad ( 3 )$$

where m is the mass flow rate of the fluid, Cp is the specific heat capacity of the fluid, T_{S} is the surface temperature of the material, T_{HS} is the surface temperature of the heat sink (bearing), Ti is the inlet temperature of the fluid as it flows into the gap, and e is the effectiveness of the heat exchange between the gas flowing in the gap and the sheet surface and the surface of the heat sink/source (the “walls” of the gap). The value of e varies from 0 (representing zero surface-to-gas heat exchange) to 1 (representing the gas fully reaching the temperature of the surfaces). The value of e for equation (3) is desirably computed by e-NTU method as understood by those skilled in the art of heat transfer.

Typically however, if the gap between the surface of the sheet and the surface of the heat sink/source is small, and/or the fluid flow rate times heat capacity is small, the value of e will be very nearly equal to 1, meaning the fluid heats nearly completely—to equal, on average, the average of the temperature of the two surfaces on either side—before it leaves the gap. Assuming e=1 (only a slight overestimate of the rate of convective heat transfer), and the fluid being supplied to the gap through the surface of the heat sink/source, it can be assumed that the initial temperature of the fluid in the gap is the same as the temperature of the surface of the heat sink/source (Ti=T_{HS}). The rate of heat transfer due to convection may then be simplified to:

$${Q}_{conv} = \dot{m} {C}_{p} ( \frac{{T}_{S} - {T}_{HS}}{2} ) \qquad ( 4 )$$

To cool (or heat, assuming the amount of radiation from the heat source when heating is not too high) the sheet principally by conduction, in the area of the gap, thus requires that:

Q_{cond}>Q_{conv} (5)

Combining (17) with equations (13) and (16) gives the following conditional:

$$\frac{k}{g} > \frac{\dot{m} {C}_{p}}{2 {A}_{g}} \qquad ( 6 )$$

which, when held, will essentially ensure that the sheet, in the area of the gap at issue, is cooled (or heated) principally by conduction. Accordingly, the mass flow rate m of the fluid should be less than 2 kAg/gCp, or 2 k/gCp per square meter of gap area. In an embodiment, m<B (2 kAg/gCp), where B is the ratio of convective cooling to conductive cooling. As used herein, B is a positive constant less than one and greater than zero.

In most cases, there is a desire to minimize the flow rate of the fluid to the bearing. In all cases, the pumping power requirement, along with the size of the pumping unit and its power supply requirement, scales with the flow rate. There is also often a desire to minimize the convective portion of the heat transfer because the bearing flow rates may not be sufficiently uniform spatially over the lateral dimensions of the sheet being processed; by making the bearing gaps very uniform and the convection term negligible, the uniformity of the heat transfer rate can be very good.

In most cases, for practical reasons associated with conveyance and minimization of buckling-inducing gravity loads that can occur in thin materials, the article will be processed such that its thinnest dimension is horizontal. In this case, a useful criterion for required flow rate to the fluid bearings is to provide enough centering stiffness such that, when gravitational forces are induced, the part will remain on the central plane of the fluid bearing within some small percentage, thereby ensuring that an approximately equal heat transfer rate occurs on either side of the material. For example, the article may be allowed to move off center by 5% of the bearing gap.

Consider a sheet being supported by a bulk porous type fluid bearing. There is symmetry about the central plane of the sheet. The fluid flow and pressure in gap can be computed by those skilled in the art of fluid bearing design. The flow through the porous media can often be modeled as Darcy flow. For one dimensional gas flow through a porous media in which the flow dynamics are dominated by viscous effects through the microcrevices of the porous media, Darcy's Law may be used to compute the local flow velocity:

$$u = \frac{k}{μ} \frac{dp}{dx} \qquad ( 7 )$$

where k is the permeability of the porous media, μ is the dynamic viscosity of the gas, and dp/dx is the local pressure gradient in the flow direction. This equation can be rearranged in a form suitable for integration:

$$\frac{dp}{u} = \frac{μ}{k} dx \qquad ( 8 )$$

The local velocity u may be computed from the mass flow rate:

$$u = \frac{\dot{m}}{ρ A} \qquad ( 9 )$$

Where \dot{m} is the mass flow rate, ρ is the gas density, and A is the area of the gas flow. The mass flow rate of the gas must remain constant as the pressure decreases within the porous media. Substituting Equation (9) into Equation (8):

$$ρ dp = \frac{\dot{m} μ}{Ak} dx \qquad ( 10 )$$

For an ideal gas, ρ=p/RT where R is the gas constant and T is the temperature of the gas. Substituting into Equation (10):

$${dp}^{2} = \frac{\dot{m} RT μ}{Ak} dx \qquad ( 11 )$$

Integrating this equation and noting boundary conditions that the pressure is equal to p1 at the inlet and p2 at the outlet gives:

$$\frac{1}{2} ( {p}_{1}^{2} - {p}_{2}^{2} ) = \frac{\dot{m} RT μ H}{Ak} \qquad ( 12 )$$

where H is the height or thickness of the porous media. Rearranging this equation to solve for the mass flow rate gives:

$$\dot{m} = k \frac{A ( {p}_{1}^{2} - {p}_{2}^{2} )}{2 μ RTH} \qquad ( 13 )$$

This is a general solution for one-dimensional, compressible, ideal gas flow through a porous media in which viscous effects dominate the frictional loss of pressure in the gas flow.

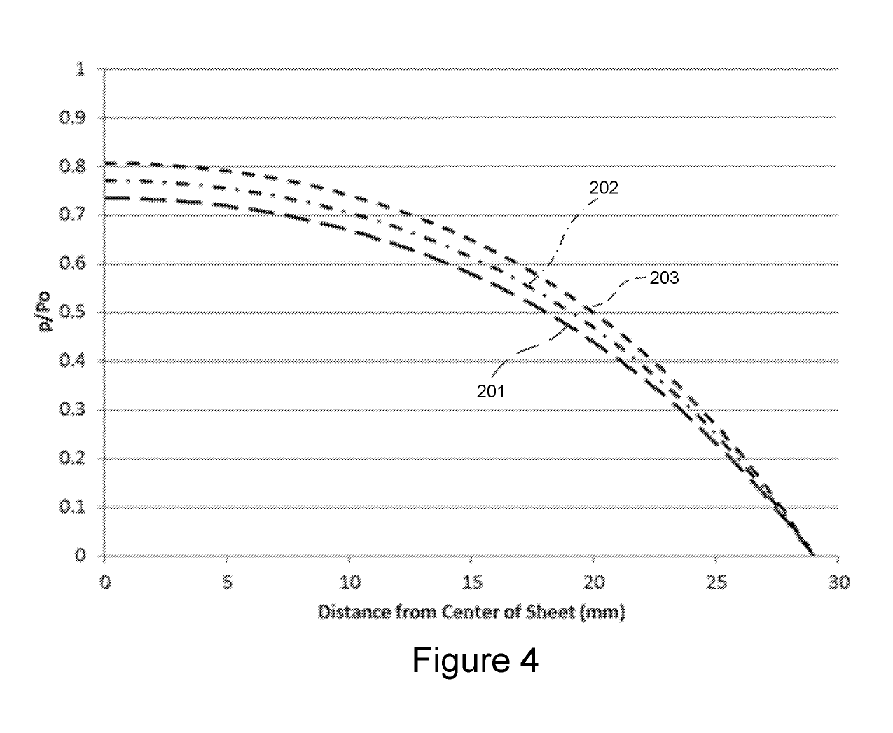

FIG. 4 shows the results of a representative fluid bearing computation in which the properties of the porous medium (thickness and permeability) and the bearing gap have been chosen to create a near-optimum design which maximizes the stiffness of the bearing. In this case p is the gage pressure of the fluid in the gap and Po is the gage supply pressure to the plenum. As shown, when the bearing is unloaded (no gravity), the central pressure is approximately 0.78 times the plenum pressure. As the bearing is loaded by gravity sufficiently to move the sheet off center by 5% of its bearing gap, the pressure in the bottom gap increases and the pressure in the top gap decreases. It is the integration of this pressure difference over the bearing area which is used to calculate the net force which balances the weight of the part.

FIG. 4 is a representative graph of normalized pressure in a gap between a sheet and a porous-media fluid bearing, computed for typical operating conditions. Note that p is the gage pressure in the gap, and Po is the plenum gage pressure. The central trace 202 is a plot of the top and bottom gap pressure, with the bearings unloaded (equivalent to a weightless sheet in the bearings). The bottom trace 201 is a plot of the top gap pressure, and the top trace 203 is a plot of the bottom gap pressure, with the bearings under load of gravity.

Consider representative calculations for various fluids (gases and liquids) shown in Table 4. In all cases, the sheet being supported is glass with a density of 2500 kg/m³, thickness of 1 mm, and lateral dimensions of 58 mm and 114 mm. The initial glass temperature as it enters the fluid bearings is 700° C. In each case, bearing calculations were performed to determine what flow rate of fluid is required to keep this part on center within 5% of the bearing gap. For each material, the weight of the part within the fluid bearings was augmented by the calculated buoyant force:

$$\frac{{F}_{net}}{A} = ( {ρ}_{sheet} - {ρ}_{fluid} ) at \qquad ( 14 )$$

Where Fₙₑₜ is the net force that the bearings must resist, A is the projected area of the sheet, ρ sheet is the density of the sheet, ρ fluid is the density of the fluid, α is the acceleration due to gravity (approximately 9.81 m/s²), and t is the sheet thickness. The Reynolds number of the fluid exiting the gap was calculated by:

$$Re = \frac{{ρ}_{fluid} {V}_{exit} ( 2 g )}{μ} \qquad ( 15 )$$

Where ρ fluid is the fluid density evaluated at the exit of the gap, μ is the fluid dynamic viscosity evaluated at the temperature of the fluid exiting the gap. A value of 2 g (with g as the width of the gap) is used as the hydraulic diameter of the fluid flow; it is known by those skilled in the art of fluid dynamics that parallel plate flow that the flow becomes turbulent at a Reynolds number of approximately 2300. It is desirable that the flow in the gap be kept in the laminar regime such that it is deterministic and can be modeled with simple fluid flow equations, but it is not necessary. In some of the cases shown in Table 4 of the very highly conductivity liquid metals, the bearing gaps were chosen to be as large as possible while keeping the Reynolds number at the exit less than 2300. The results shown are the computed fluid bearing design parameters to float a glass sheet that has dimensions of 1 mm×58 mm×114 mm, a density of 2500 kg/m³, and which is cooled from an initial starting temperature of 700° C.

TABLE 4

| | Fluid Type | | | | |
|---|---|---|---|---|---|
| | Air | He | NaNO₃ | KNO₃ | Sn |
| | Bearing Operating Temperature (° C.) | | | | |
| | 25 | 25 | 320 | 350 | 240 |
| Average Fluid | 363 | 363 | 510 | 525 | 470 |
| Temperature | | | | | |
| in Gap (° C.) | | | | | |
| Thermal Conductivity | 0.047 | 0.238 | 0.47 | 0.32 | 35.0 |
| @ Average Gap | | | | | |
| Temperature (W/m/° C.) | | | | | |
| Dynamic Viscosity | 1.84E−05 | 2.00E−05 | 0.00285 | 0.00278 | 0.00131 |
| @ Bearing | | | | | |
| Temperature (Pa s) | | | | | |
| Dynamic Viscosity | 3.11E−05 | 3.49E−05 | 0.001 | 0.00134 | 0.00108 |
| @ Average Gap | | | | | |
| Temperature (Pa s) | | | | | |
| Fluid Density at | 0.5555 | 0.0768 | 1900 | 1865 | 6950 |
| Exit of Gap (kg/m³) | | | | | |
| Fluid Specific Heat | 1020 | 5200 | 1650 | 1370 | 210 |
| Capacity (J/kg/° C.) | | | | | |
| Bearing Gap Per | 60 | 100 | 100 | 80 | 480 |
| Side (microns) | | | | | |
| Porous Bearing | 15 | 15 | 15 | 15 | 15 |
| Thickness (mm) | | | | | |
| Porous Bearing Darcy | 3.90E−12 | 3.90E−12 | 1.90E−12 | 7.20E−12 | 9.30E−10 |
| Flow Permeability | | | | | |
| Constant (m²/s) | | | | | |
| Computed Flow Rate | 0.11 | 0.46 | 0.0038 | 0.00154 | 2.93 |
| Per Side Required to | | | | | |
| Center Glass within | | | | | |
| 5% of Gap (liters | | | | | |
| per minute) | | | | | |
| Plenum Pressure if | 185 | 185 | 44.5 | 47 | 329 |
| Glass is Centered (Pa) | | | | | |
| Reynolds Number at | 0.47 | 0.24 | 3.5 | 0.14 | 2160 |
| Exit of Gap | | | | | |
| Initial Conduction | 3473 | 10643 | 11809 | 9257 | 221959 |
| Heat Transfer Rate | | | | | |
| from One Side of | | | | | |
| Glass to Bearing (W) | | | | | |
| Initial Convection | 0.35 | 1.0 | 38 | 11 | 16393 |
| Heat Transfer Rate | | | | | |
| from One Side of | | | | | |
| Glass to Fluid (W) | | | | | |
| Ratio of Convection | 0.0001 | 0.0001 | 0.003 | 0.001 | 0.074 |
| to Conduction | | | | | |
| Effective Initial | 0.0185 | 0.0568 | 0.0631 | 0.0494 | 1.19 |
| Conduction Heat | | | | | |
| Transfer Coefficient | | | | | |
| as if Material was | | | | | |
| Subjected to 25° C. | | | | | |
| (cal/cm²/s/° C.) | | | | | |

| | Fluid Type | | | |
|---|---|---|---|---|
| | Sn | Pb | Pb | Na |
| | Bearing Operating Temperature (° C.) | | | |
| | 630 | 330 | 580 | 110 |
| Average Fluid | 665 | 515 | 640 | 405 |
| Temperature | | | | |
| in Gap (° C.) | | | | |
| Thermal Conductivity | 39.5 | 18.7 | 20.6 | 71.1 |
| @ Average Gap | | | | |
| Temperature (W/m/° C.) | | | | |
| Dynamic Viscosity | 0.00100 | 0.00250 | 0.00160 | 0.000509 |
| @ Bearing | | | | |
| Temperature (Pa s) | | | | |
| Dynamic Viscosity | 0.00099 | 0.00183 | 0.00138 | 0.000259 |
| @ Average Gap | | | | |
| Temperature (Pa s) | | | | |
| Fluid Density at | 6950 | 10600 | 10600 | 930 |
| Exit of Gap (kg/m³) | | | | |
| Fluid Specific Heat | 210 | 160 | 160 | 1364 |
| Capacity (J/kg/° C.) | | | | |
| Bearing Gap Per | 425 | 500 | 390 | 610 |
| Side (microns) | | | | |
| Porous Bearing | 15 | 15 | 15 | 15 |
| Thickness (mm) | | | | |
| Porous Bearing Darcy | 5.30E−10 | 1.15E−09 | 4.70E−10 | 3.05E−09 |
| Flow Permeability | | | | |
| Constant (m²/s) | | | | |
| Computed Flow Rate | 2.2 | 3.5 | 2.22 | 8.76 |
| Per Side Required to | | | | |
| Center Glass within | | | | |
| 5% of Gap (liters | | | | |
| per minute) | | | | |
| Plenum Pressure if | 329 | 600 | 600 | 116 |
| Glass is Centered (Pa) | | | | |
| Reynolds Number at | 2126 | 2067 | 2048 | 2228 |
| Exit of Gap | | | | |
| Initial Conduction | 43001 | 91704 | 41894 | 454706 |
| Heat Transfer Rate | | | | |
| from One Side of | | | | |
| Glass to Bearing (W) | | | | |
| Initial Convection | 1873 | 18303 | 3765 | 54635 |
| Heat Transfer Rate | | | | |
| from One Side of | | | | |
| Glass to Fluid (W) | | | | |
| Ratio of Convection | 0.044 | 0.200 | 0.090 | 0.120 |
| to Conduction | | | | |
| Effective Initial | 0.230 | 0.490 | 0.224 | 2.43 |
| Conduction Heat | | | | |
| Transfer Coefficient | | | | |
| as if Material was | | | | |
| Subjected to 25° C. | | | | |
| (cal/cm²/s/° C.) | | | | |

In some cases it may be desirable to reduce the convection portion of the heat transfer to very low levels compared to the conduction term. A configuration such as that shown in FIG. 3 could be employed. In this case, the requirement of supporting the sheet is eliminated and the flow rates can be turned down to very low values. Example calculations are shown in Table 5. In all cases, the flow rates were chosen such that the convection is approximately 1% of conduction. Flow conditions were computed across a heat transfer land such as shown and described with respect to FIG. 3 above, where a glass sheet that has dimensions of 1 mm thick×58 mm length (in the direction into the page of the figure) is cooled from an initial starting temperature of 700° C.

TABLE 5

| | Fluid Type | | | | | |
|---|---|---|---|---|---|---|
| | Air | He | NaNO₃ | KNO₃ | Sn | Sn |
| | Land Operating Temperature (° C.) | | | | | |
| | 25 | 25 | 320 | 350 | 240 | 630 |
| Average Fluid | 363 | 363 | 510 | 525 | 470 | 665 |
| Temperature | | | | | | |
| in Gap (° C.) | | | | | | |
| Thermal Conductivity | 0.047 | 0.238 | 0.47 | 0.320 | 35.0 | 39.5 |
| @ Average Gap | | | | | | |
| Temperature (W/m/° C.) | | | | | | |
| Dynamic Viscosity | 3.11E−05 | 3.49E−05 | 0.001 | 0.00134 | 0.00108 | 0.00099 |
| @ Average Gap | | | | | | |
| Temperature (Pa s) | | | | | | |
| Fluid Density at | 0.5555 | 0.0768 | 1900 | 1865 | 6950 | 6950 |
| Exit of Gap (kg/m³) | | | | | | |
| Fluid Specific Heat | 1020 | 5200 | 1650 | 1370 | 210 | 210 |
| Capacity (J/kg/° C.) | | | | | | |
| Land Gap Per | 40 | 55 | 60 | 38 | 2800 | 480 |
| Side (microns) | | | | | | |
| Land Width (mm) | 12 | 12 | 12 | 12 | 12 | 12 |
| Flow Rate per Land | 1.72 | 9.07 | 0.00209 | 0.0027 | 0.0072 | 0.046 |
| (liters per minute) | | | | | | |
| Supply Pressure (Pa) | 34561 | 78819 | 400 | 2728 | 0.0015 | 17 |
| Reynolds Number at | 18 | 11 | 2.3 | 2 | 27.0 | 185 |
| Exit of Gap | | | | | | |
| Initial Conduction | 7.88E+05 | 2.93E+06 | 2.98E+06 | 2.95E+06 | 5.75E+06 | 5.76E+06 |
| Heat Flux Rate from | | | | | | |
| One Side of Glass | | | | | | |
| to Bearing (W/m²) | | | | | | |
| Initial Convection | 7877 | 29261 | 29811 | 28910 | 57877 | 56269 |
| Heat Flux Rate from | | | | | | |
| One Side of Glass | | | | | | |
| to Fluid (W/m²) | | | | | | |
| Ratio of Convection | 0.010 | 0.010 | 0.010 | 0.010 | 0.010 | 0.010 |
| to Conduction | | | | | | |
| Effective Initial | 0.0278 | 0.103 | 0.105 | 0.104 | 0.203 | 0.203 |
| Conduction Heat | | | | | | |
| Transfer Coefficient | | | | | | |
| as if Material was | | | | | | |
| Subjected to 25° C. | | | | | | |
| (cal/cm²/s/° C.) | | | | | | |

| | Fluid Type | | | |
|---|---|---|---|---|
| | Pb | Pb | Na | Na |
| | Land Operating Temperature (° C.) | | | |
| | 330 | 580 | 110 | 600 |
| Average Fluid | 515 | 640 | 405 | 650 |
| Temperature | | | | |
| in Gap (° C.) | | | | |
| Thermal Conductivity | 18.7 | 20.6 | 71.1 | 60.0 |
| @ Average Gap | | | | |
| Temperature (W/m/° C.) | | | | |
| Dynamic Viscosity | 0.00183 | 0.00138 | 0.00026 | 0.00005 |
| @ Average Gap | | | | |
| Temperature (Pa s) | | | | |
| Fluid Density at | 10600 | 10600 | 930 | 930 |
| Exit of Gap (kg/m³) | | | | |
| Fluid Specific Heat | 160 | 160 | 1364 | 1364 |
| Capacity (J/kg/° C.) | | | | |
| Land Gap Per | 1200 | 430 | 2500 | 1060 |
| Side (microns) | | | | |
| Land Width (mm) | 12 | 12 | 12 | 12 |
| Flow Rate per Land | 0.0076 | 0.024 | 0.0188 | 0.038 |
| (liters per minute) | | | | |
| Supply Pressure (Pa) | 0.33 | 17 | 0.013 | 0.067 |
| Reynolds Number at | 25.0 | 106 | 39.0 | 403 |
| Exit of Gap | | | | |
| Initial Conduction | 5.78E+06 | 5.75E+06 | 1.68E+07 | 5.66E+0 6 |
| Heat Flux Rate from | | | | |
| One Side of Glass | | | | |
| to Bearing (W/m²) | | | | |
| Initial Convection | 57102 | 58483 | 168468 | 57715 |
| Heat Flux Rate from | | | | |
| One Side of Glass | | | | |
| to Fluid (W/m²) | | | | |
| Ratio of Convection | 0.010 | 0.010 | 0.010 | 0.010 |
| to Conduction | | | | |
| Effective Initial | 0.204 | 0.203 | 0.592 | 0.200 |
| Conduction Heat | | | | |
| Transfer Coefficient | | | | |
| as if Material was | | | | |
| Subjected to 25° C. | | | | |
| (cal/cm²/s/° C.) | | | | |

The present disclosure provides the particular advantage of higher heat exchange rates (higher effective coefficients of heat exchange) during glass tempering than perhaps any other methods, while avoiding or minimizing the effects of thermally driven convection currents (due to the small thickness dimension of the liquid layer employed). This combination allows the production of both higher stresses (with resulting higher strength) in a thermally strengthened glass sheet as a function of thickness, and higher stress homogeneity at such stress levels. Also, relatively high strength glass products can be produced while avoiding the potential cost and uncertainty of He supply. Other aspects and advantages will be apparent from a review of the specification as a whole.

The construction and arrangements of the equipment, articles and materials as shown in the various exemplary embodiments are illustrative only. Although only a few embodiments have been described in detail in this disclosure, many modifications are possible (e.g., variations in sizes, dimensions, structures, shapes, and proportions of the various elements, values of parameters, mounting arrangements, use of materials, orientations) without materially departing from the novel teachings and advantages of the subject matter described herein. For example, both flat and curved glass articles may be tempered according to the methods described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present inventive technology.

1. Process of strengthening a glass sheet, the process comprising:
a. supporting at least a portion of a glass sheet on a first surface thereof, at least in part, by a flow or a pressure of a liquid delivered to a first gap between the first surface and a first heat sink surface, the first heat sink surface comprising a solid, wherein the sheet comprises or consists of a glass having a glass transition temperature and the sheet is at a temperature greater than the glass transition temperature of the glass;
b. cooling the first surface of the sheet, with more than 20% of said cooling being by thermal conduction from the first surface of the sheet across the first gap through the liquid to the first heat sink surface.

2. The process according to claim 1 further comprising
a. contacting at least a portion of the glass sheet on a second surface thereof, at least in part, with a flow or a pressure of a liquid delivered to a second gap between the second surface and a second heat sink surface, the second heat sink surface comprising a solid;
b. cooling the second surface of the sheet, with more than 20% of said cooling being by thermal conduction from the second surface of the sheet across the second gap through the liquid to the second heat sink surface.

3. The process according to claim 1 further comprising
prior to cooling the sheet, heating the first surface of the sheet, with more than 20% of said heating being by thermal conduction from a first heat source surface across a third gap through a fluid to the first surface of the sheet.

4. The process according to claim 1, further comprising
prior to cooling the sheet, heating the second surface of the sheet, with more than 20% of said heating being by thermal conduction from a second heat source surface across a fourth gap through a heat conduction fluid, to the second surface of the sheet.

5. The process according to claim 3, wherein the fluid is a gas.

6. The process according to claim 3, wherein the fluid is a liquid.

7. The process according to claim 3, wherein more than 30% of said heating is by thermal conduction.

8. The process according to claim 3, wherein more than 40% of said heating is by thermal conduction.

9. The process according to claim 3, wherein more than 50% of said heating is by thermal conduction.

10. The process according to claim 1, wherein more than 30% of said cooling is by thermal conduction.

11. The process according to claim 10, wherein more than 40% of said cooling is by thermal conduction.

12. The process according to claim 10, wherein more than 50% of said cooling is by thermal conduction.

13. A process of strengthening a glass sheet, the process comprising:
cooling a sheet or portion of a sheet, the sheet comprising or consisting of a glass having a glass transition temperature, given in units of ° C., of T, wherein the cooling is performed (a) starting with the sheet at a temperature above T, (b) with more than 20% of said cooling, at some point during said cooling, being by thermal conduction through a liquid to a heat sink surface comprising a solid.

14. The process according to claim 13 wherein said cooling is performed to below a temperature of T±0.02·T° C.

15. The process according to claim 13 wherein said cooling is performed to below a temperature of T±0.10·T° C.

16. The process according to claim 13 wherein said cooling is performed to below a temperature of T±0.051·T° C.

17. The process according to claim 13 wherein said cooling is performed to below a temperature of T° C.

18. The process according to claim 13, wherein more than 30% of said cooling is by thermal conduction.

19. The process according to claim 18, wherein more than 40% of said cooling is by thermal conduction.

20. The process according to claim 18, wherein more than 50% of said cooling is by thermal conduction.

21. The process according to claim 13, further comprising
prior to cooling the sheet or portion of a sheet, heating the sheet, wherein the heating is performed with more than 20% of said heating, at some point during said heating, being by thermal conduction from a heat source surface through a fluid to the sheet.

22. The process according to claim 21, wherein more than 30% of said heating is by thermal conduction.

23. The process according to claim 21, wherein more than 40% of said heating is by thermal conduction.

24. The process according to claim 21, wherein more than 50% of said heating is by thermal conduction.

25. A process for heat treating an article, the process comprising:
heating or cooling an article, at least 50% of said heating or cooling performed, during at least some time of said heating or cooling, by thermal conduction through a liquid to a heat sink surface comprising a solid.
